(19) United States
(12) Patent Application Publication
(10) Pub. No.: US 2016/0291422 A1
(43) Pub. Date: Oct. 6, 2016

(54) REFRACTIVE-INDEX DISTRIBUTION TYPE LIQUID CRYSTAL OPTICAL DEVICE, IMAGE DISPLAY APPARATUS, AND LIQUID CRYSTAL OPTICAL ELEMENT

(71) Applicant: KABUSHIKI KAISHA TOSHIBA, Tokyo (JP)

(72) Inventors: Ayako TAKAGI, Yokosuka (JP); Shinichi UEHARA, Tokyo (JP); Masako KASHIWAGI, Kawasaki (JP)

(73) Assignee: Kabushiki Kaisha Toshiba, Tokyo (JP)

(21) Appl. No.: 14/993,446

(22) Filed: Jan. 12, 2016

(30) Foreign Application Priority Data
Mar. 30, 2015 (JP) 2015-070388

(51) Int. Cl. G02F 1/1343; G02F 1/133

(52) U.S. Cl. CPC G02F 1/134309; G02F 1/13306

(57) ABSTRACT

A refractive-index distribution type liquid crystal optical device includes an optical element and a controller. The optical element includes a first and a second substrate, a liquid crystal layer, a first electrodes and second electrodes provided between the first substrate and the liquid crystal layer, third electrodes and fourth electrodes provided between the second substrate and the liquid crystal layer. Each of the second electrodes is between a pair of the first electrodes. Each of the plurality of second electrodes has a pair of end portions and a center portion being between the pair of end portions. A pair of the third electrodes are provided between a pairs of the fourth electrodes. The third electrode overlaps with the end portions the second, electrode and the third electrodes are projected onto the surface of the first substrate. The controller applies voltages to each of the electrodes.

### CROSS-REFERENCE TO RELATED APPLICATIONS

This application is based upon and claims the benefit of priority from Japanese Patent Application No. 2015-070388, filed Mar. 30, 2015, the entire contents of which are incorporated herein by reference.

### FIELD

Embodiments described herein relate generally to a refractive-index distribution type liquid crystal optical device, image display apparatus and liquid crystal optical element.

### BACKGROUND

Liquid crystal optical devices capable of changing a refractive-index distribution in dependence on an applied voltage, with birefringence of the liquid crystal molecules, have been proposed. Image display apparatuses comprising such liquid crystal optical devices in combination with display elements also have been proposed.

By changing the refractive-index distribution of the liquid crystal optical device, the image display apparatuses can be made to display an image on the display element so that the image is either directly incident on a viewer's eyes, or is incident on the viewer's eyes at some parallax angle. In this manner, this image display apparatus can be switched between two-dimensional (2D) display and three-dimensional (3D) display. A technique to change an optical path using a Fresnel zone plate has also been proposed. There has been a demand for such display apparatus having high display quality.

### BRIEF DESCRIPTION OF THE DRAWINGS

FIG. 1A is a sectional view of a refractive-index distribution type liquid crystal optical device according to a first embodiment;

FIG. 1B is a enlarged view of a part of a refractive-index distribution type liquid crystal optical device shown in FIG. 1A;

FIG. 2 is a sectional view of an image display apparatus according to the first embodiment;

FIG. 3A is a diagram of a distribution of potentials of a refractive-index distribution type liquid crystal optical device according to reference sample 1;

FIG. 3B is an enlarged sectional view of a part of a refractive-index distribution type liquid crystal optical device according to a reference sample 1;

FIG. 4A is a diagram of distribution of potentials of a refractive-index distribution type liquid crystal optical device according to a reference sample 2;

FIG. 4B is an enlarged sectional view of a part of a refractive-index distribution type liquid crystal optical device according to the reference sample 2;

FIG. 5 is a diagram of a refractive-index distribution of liquid, crystal optical devices according to the reference sample 1 and the reference sample 2.

FIG. 6A is a sectional view of an image display apparatus according to a second embodiment;

FIG. 6B is an enlarged view of a part of an image display apparatus shown in FIG. 6A;

FIG. 7 is a sectional view illustrating an image display apparatus according to a third embodiment;

FIG. 8 is an exploded perspective view of electrodes according to the third embodiment;

FIG. 9 is a sectional view of an image display apparatus according to a fourth embodiment;

### DETAILED DESCRIPTION

Each of the embodiments will now be described in detail with reference to the accompanying drawings.

Note that the figures are conceptual pattern diagrams, and the relationships between thicknesses and widths and ratios of size of each part are not necessarily represented to scale. Moreover, the size and ratio of components that appear in multiple figures are not necessarily the same in each figure.

According to one embodiment, a refractive-index distribution type liquid crystal optical device includes an optical element and a controller. The optical element includes a first substrate, a second substrate, a liquid crystal layer, a plurality of first electrodes, a plurality of second electrodes, a plurality of pairs of third electrodes, and a plurality of pairs of fourth electrodes.

The first substrate has a surface. The liquid crystal layer is between the surface of the first substrate and the second substrate. The plurality of first electrodes are between the surface of the first substrate and the liquid crystal layer, and arranged along a first direction parallel to the surface.

The plurality of second electrodes are between the surface of the first substrate and the liquid crystal layer. Each of the plurality of second electrodes is between the plurality of first electrodes. Each of the plurality of second electrodes has a pair of end portions and a center portion being between the pair of end portions.

The plurality of pairs of third electrodes are between the second substrate and the liquid crystal layer.

The plurality of pairs of fourth electrodes are between the second substrate and the liquid crystal layer. The plurality of pairs of fourth electrodes are arranged along the first direction with the plurality of pairs of third electrodes.

The pairs of the third electrodes are provided between the pairs of the fourth electrodes. Each of the fourth electrodes overlaps with each of first centers of widths of the first electrodes along the first direction when the fourth electrodes are projected onto the surface.

Each of the pairs of the third electrodes overlaps with end portions of each of the pairs of of the second electrodes when the plurality of the second electrodes and the plurality of pairs of the third electrodes are projected onto the surface.

The controller applies a first voltage to the plurality of first electrodes, a second voltage to the plurality of second electrodes, a third voltage to the plurality of pairs of the third electrodes, a fourth voltage to the plurality of pairs of the fourth electrodes.

The first voltage, the second voltage, the third voltage, the fourth voltage satisfy following relations;

|V2−V3|>|V1−V3|

|V1−V4|>|V1−V3|

Where V1 is the first voltage, V2 is the second voltage, V3 is the third voltage, and V4 is the fourth voltage.

### First Embodiment

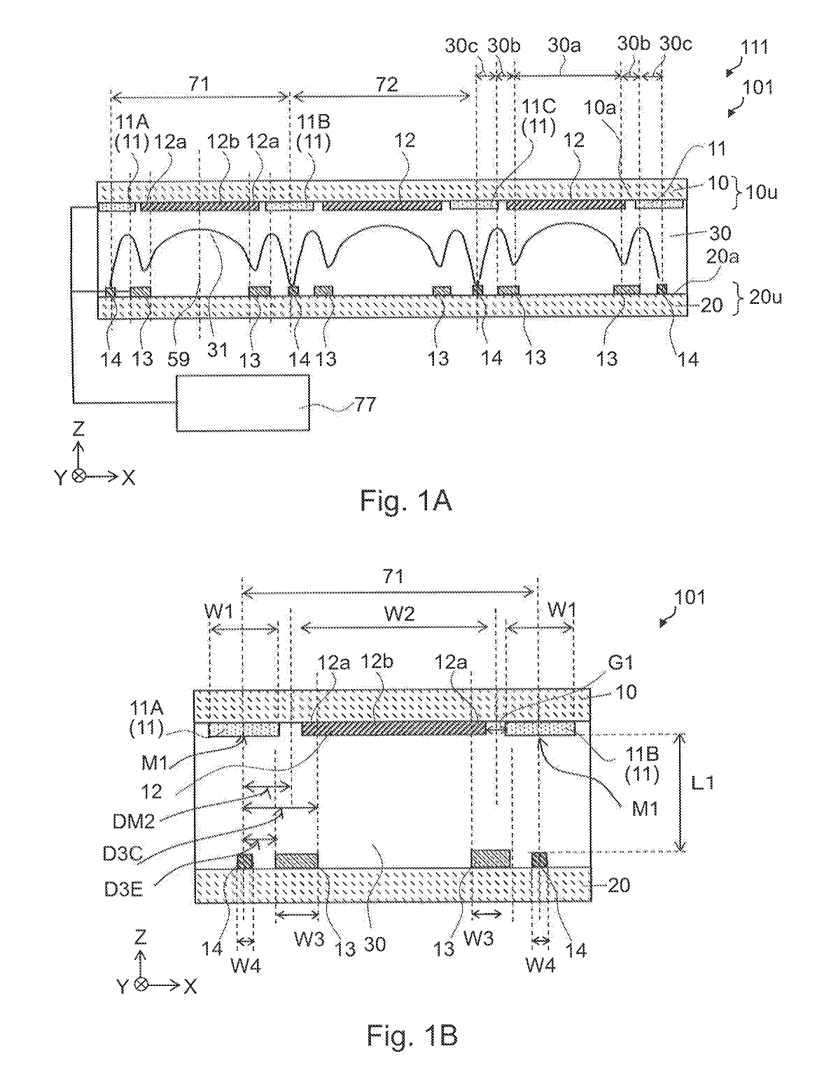

FIG. 1A is a sectional view of a refractive-index distribution type liquid crystal optical device according to a first embodiment. FIG. 1B is an enlarged view of a part of the refractive-index distribution type liquid, crystal optical device shown in FIG. 1A.

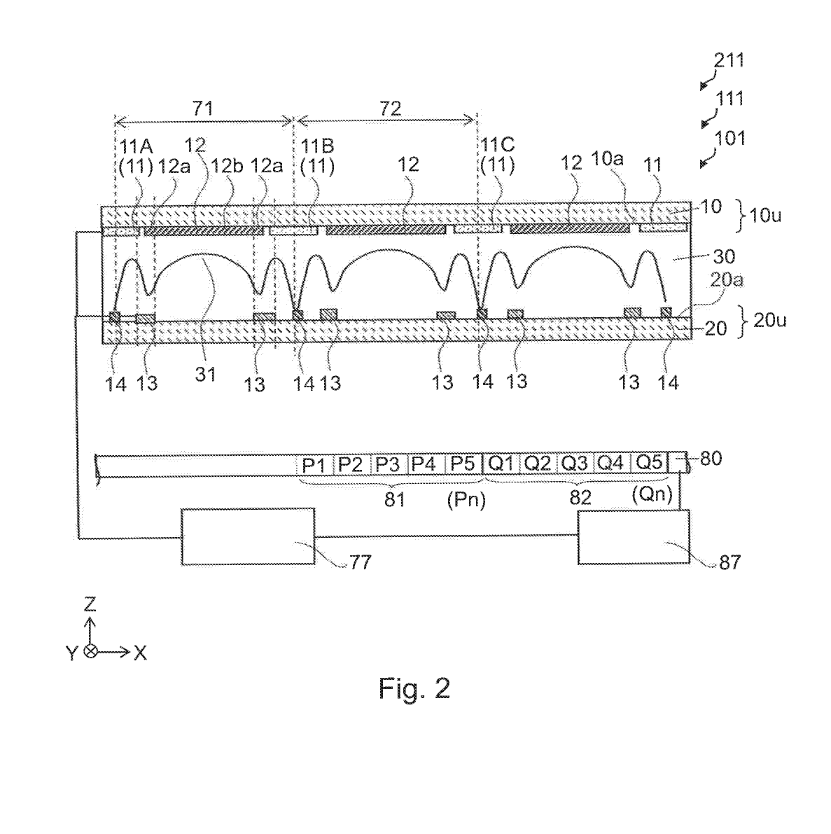

FIG. 2 is a sectional view of an image display apparatus according to the first embodiment. An image display apparatus 211 according to this embodiment includes a liquid crystal optical device 111, a display element 80, and a display circuit 87.

The liquid crystal optical device 111 includes a liquid crystal optical element 101 and a controller 77. The liquid crystal optical element 101 includes a first substrate unit 10u, a second substrate unit 20u, and a liquid crystal layer 30. The liquid crystal layer 30 is provided between the first substrate unit 10u and the second substrate unit 20u.

The liquid crystal optical device 101 is able to be placed in a first state to in which the passage of incident light is substantively changed, or in a second state in which the passage of light is not changed substantively. In other words, the first state is a state in which the reflective-index distribution 31 is caused to occur in the liquid crystal layer 30, and the second state is a state the reflective-index in the liquid crystal layer 30 is caused to be uniform. When light is incident to the liquid crystal optical element 101 in first state, the image display apparatus 211 provides a three-dimensional display. And when light is incident to the liquid crystal optical element 101 in the second state, the image display apparatus 211 provides a two-dimensional display. The first state and the second state are switched by changing the state of the liquid crystal layer 30 under the command of controller 77.

The first substrate unit 10u includes a first substrate 10, a plurality of first electrodes 11, and a plurality of second electrodes 12. The first substrate 10 has a first surface 10a. The plurality of first electrodes 11 and the plurality of second electrodes 12 are provided between the first surface 10a of the first substrate 10 and the liquid crystal layer 30. The plurality of first electrodes 11 are arranged along a first direction parallel to the first surface. Each of the plurality of second electrodes 12 are provided between each of the plurality of first electrodes 11.

In FIG. 1, the first direction is defined as the X direction. The second direction, perpendicular to the first surface 10a, is defined as the Z direction. A third direction perpendicular to X direction and Z direction is defined as the Y direction. The X-Y plane is thus parallel to the first surface 10a.

Each of the plurality of first electrodes 11 is, for example, extended along the Y direction parallel to the first surface 10a and perpendicular to the first (X) direction.

The second substrate unit 20u includes a second substrate 20, a third electrode 13, and a fourth electrode 14. The second substrate 20 has a second surface 20a being opposed to the first surface 10a. In this specification, the state of being opposed includes not only the state in which the elements are opposed directly but also the state in which the elements are opposed and something is inserted between them. A plurality of pairs of the third electrodes 13 are provided between the second surface 20a of the second substrate 20 and the liquid crystal layer 30. A plurality of the third electrodes 13 are arranged in pairs along the first (X) direction. For example, the plurality of pairs of the third electrodes 13 extends along Y direction.

A plurality of pairs of fourth electrodes 14 are provided between the second surface 20a of the second substrate 20 and the liquid crystal layer 30. A plurality of the third electrodes 13 are arranged in pairs along the first (X) direction. For example, the plurality of pairs of the third electrodes 13 extends along Y direction. A plurality of pairs of the fourth electrodes 14 are arranged with the pairs of third electrodes 13 along the first (X) direction. Each of the pairs of third electrodes 13 is provided between a pair of fourth electrodes 14. For example, the plurality of pairs of the fourth electrodes 14 extend along the third (Y) direction.

The first substrate unit 10u and the second substrate unit 20u may include an alignment film.

The liquid crystal layer 30 is provided between the first substrate 10 and the second substrate 20.

The first substrate 10, the second substrate 20, the first electrode 11, the second electrode 12, the third electrode 13, and the fourth electrode 14 are able to transmit light. The first substrate 10, the second substrate 20, the first electrode 11, the second electrode 12, the third electrode 13, and the fourth electrode 14 are, for example, transparent or semi-transparent.

In one embodiment, for example, glass and resin are used for the first substrate 10 and the second substrate 20. The first substrate 10 and the second substrate 20 may be planar or sheeted. For example, the thicknesses of the first substrate 10 and the second substrate 20 may be not less than 50 micrometer (μm) and not more than 200 μm. Note, however, that the thicknesses may be chosen arbitrarily and are not critical parameters.

For example, the first electrode 11, the second electrode 12, the third electrode 13, and the fourth electrode 14 may comprise an oxide, including at least an element selected from a group of Indium (In), Tin (Sn), Zinc (Zn), and Titanium (Ti). For example Indium Tin oxide (ITO) may be used for these electrodes. As another example, at least Indium oxide (In₂O₃) or Tin oxide (SnO₃) may be used for these electrodes. The thicknesses of these electrodes may be, for example, not less than 100 nanometer (nm) and not more than 350 nm. As another example, the thicknesses of these electrodes may be not less than 150 nanometer (nm) and not more than 250 nm. The thicknesses of these electrodes may be chosen to provide for high transmittance of visible light.

For example, a pitch of the first electrodes (a distance between centers of the first electrodes 11 that are proximate each other along X direction) may be not less than 10 μm and not more than 1000 μm. This pitch is designed arbitrarily. A gap between the first electrode 11 and the second electrode 12 provided proximate to the first electrode 11 may be not less than 5 μm and not more than 20 μm.

In one example, a width W1 of the first electrode 11 along first direction may be not less than 5 μm and not more than 300 μm. For example, a width W2 of the second electrode 12 may be not less than 5 μm and not more than 300 μm. For example, a width W3 of the third electrode 13 may be not less than 5 μm and not more than 30 μm. For example, the width W2 of the second electrode 12 may be larger than the width W3 of the third electrode 13.

The liquid crystal layer 30 includes a liquid crystal material. For example, nematic liquid crystal (nematic liquid crystal at an operating temperature of liquid crystal optical device 111) may be used for the crystal material. The liquid crystal material may have positive dielectric constant anisotropy or negative dielectric constant anisotropy. In the case of positive dielectric constant anisotropy, for example, the initial alignment of liquid crystal in the liquid crystal layer 30 (the alignment appearing when voltage is not applied to liquid crystal layer 30) may be substantially horizontal. In the case of negative dielectric constant anisotropy, the initial alignment of liquid crystal in the liquid crystal layer 30 may be substantially vertical.

In this specification, horizontal alignment refers to an angle between the director of the liquid crystal (long axis of liquid crystal molecules) and X-Y plane (pretilt angle) of not less than 0 degree (°) and not more than 30°. Vertical alignment refers to a pretilt angle of not less than 60° and not more than 90°. At initial alignment or at an alignment appearing when voltage is applied to the liquid crystal layer 30, the directors have components parallel to the X direction.

A case in which the dielectric constant anisotropy of liquid crystal included in liquid crystal layer 30 is positive and the initial alignment is substantially vertical will be described.

When the alignment is substantively vertical, directors are substantially parallel to the X direction at initial alignment. For example, when the director is projected onto X-Y plane, the angle between the director and the X direction is not more than 15°. For example, the alignment direction in liquid crystal near the second substrate unit 20u is opposite to the alignment direction in liquid crystal near the first substrate unit 10u. That is, the initial alignment is not a splay alignment.

The first substrate unit may furthermore include alignment film (not illustrated in figures). For example polyimide may be used for this alignment film.

The controller 77 controls voltage of first electrode 11, second electrode 12, third electrode 13, and fourth electrode 14. The controller 77 is able to switch the liquid crystal layer 30 between first state and second state. The controller 77 is electrically connected to the plurality of first electrodes 11, the plurality of second electrodes 12, the plurality of third electrodes 13, and the plurality of fourth electrodes 14. The controller 77 applies voltage between each of first electrodes 11, second electrodes 12, third electrodes 13, fourth electrodes 14, and ground. For example, the controller 77 applies first voltage V1 to the plurality of first electrodes 11, second voltage V2 to the plurality of second electrodes 12, third voltage V3 to the plurality of third electrodes 13, and fourth voltage V4 to the plurality of fourth electrodes 14.

In first state, controller 77 may change alignment of liquid crystal, and provide reflective-index distribution 31 in the liquid crystal layer 30. Reflective-index distribution 31 is illustrated schematically in FIG. 1A. The first state of the liquid crystal layer 30 will now be described.

One of the plurality of the first electrodes 11 is a first electrode 11A, another of the plurality of first electrodes 11 is a first electrode 11B, another of the plurality of first electrodes 11 is a first electrode 11C. The first electrode 11B is provided between the first electrode 11A and the first electrode 11C. The first electrodes 11A-11C may be collectively called first electrode 11.

In a sectional view of liquid crystal optical device 11 which is parallel to X-Z plane, a distance between a center of a first electrode 11A in the X direction and a center of a first electrode 11B in the X direction is substantially the same as a distance between a center of a first electrode 11B in the X direction and a center of a first electrode 11C in the X direction.

In the first state, the liquid crystal layer 30 comprises a plurality of lens portions. The plurality of lens portions comprises a first lens portion 71 and a second lens portion 72. The first lens portion 71 is a portion between a central line of a first electrode 11A parallel to the Y direction and a central line of a first electrode 11B parallel to the Y direction when the liquid crystal layer 30 is projected onto the plane parallel to the first surface 10a (X-Y plane). The second lens portion 72 is a portion between a central line of a first electrode 11B and a central line of a first electrode 11C when the liquid crystal layer 30 is projected onto the plane parallel to the first surface 10a (X-Y plane). The central lines of first electrode 11A˜11C parallel to Y direction are lines passing through the center of width of first electrode 11A˜11C in the first direction. A reflective-index distribution 31 in the second lens portion 72 is substantially the same as a reflective-index distribution 31 in the first lens portion 71. A reflective-index distribution 31 in the first lens portion will now be explained.

A center plane 59 is a plane passing through a center of line segment connecting a center of first electrode 11A in the X direction and a center of first electrode 11B in the X direction and being parallel to Y-Z plane. For example, the center plane 59 is a plane passing through the center of second electrode 12 in the X direction and being parallel to the Y-Z plane. Reflective-index distribution 31 of first lens portion 71 has plane symmetry. To acquire an optical property or due to manufacturing error, for example, reflective-index distribution 31 of the first lens portion 71 is asymmetrical with respect to the center plane 59. Reflective-index distribution 31 of the first lens portion 71 is symmetrical to the center plane 59, as explained below.

A portion between the central plane and a first electrode 11 (for example the first electrode 11B) in the first lens portion 71 will be explained.

The liquid crystal layer 30 comprises a first portion 30a, a second portion 30b, and third portion 30c arranged along a +X direction from center plane 59 to the first electrode 11 in the first state. The first, portion 30a is a portion in which the refractive-index n decreases along the +X direction. The second portion 30b is a portion in which the refractive-index n increases along the +X direction. The third portion 30c is a portion in which the refractive-index n decreases along the +X direction.

For example, the liquid crystal optical element 101 has an optical property of a Fresnel lens. For example, the reflective-index distribution 31 may have a shape corresponding to the distribution of thickness of a Fresnel lens. The liquid crystal optical element 101 may function as a GRIN lens (Gradient Index lens) in which refractive index n changes in a plane. In the case where the liquid crystal optical element 101 has an optical property of a Fresnel lens, the liquid crystal optical element 101 may be thin and have quick responsibility.

For example the liquid crystal optical element 101 in this embodiment functions as a cylindrical lens such as element of a Fresnel lens. Each of the elements of the Fresnel lens has a curvature along X direction of FIG. 1A, and each Fresnel lens can control the direction of incident light. On the other hand, because each element of the Fresnel lens does not have a curvature in the Y direction, the direction of incident light little changes when the incident light passes through the parallel plane glass. For example, the liquid crystal optical element 101 may function as a fly-eye lens being one element of the Fresnel lens.

The display element 80 will be described.

For example, liquid crystal element, organic EL (electro luminescence) display element, and plasma display may be used for display element 80. The embodiment is not limited to these, and arbitrary display device may be used for the display element 80. The display element 80 may be stacked with liquid crystal optical element 101. In this specification, a state of being stacked includes not only the state in which the elements are stacked to contact each other directly but also the state in which the elements are stacked and something is inserted between them.

The display element 30 emits an image toward the device. The display element 80 comprises a plurality of element image regions. A plurality of element image regions includes a first element image region 81 and a second element image region 82. An element image region corresponds to a lens portion. For example, the first element image region 81 corresponds to second lens portion 12.

Note that, in this specification, the structure in which a position of an element image region projected onto to X-Y plane coincide with a position of lens portion projected onto X-Y plane will be described, but a position of the element image region projected onto X-Y plane may not coincide with a position of lens portion projected onto X-Y plan. For example, gaps between the centers of element image regions and the centers of lens portions may gradually increase from a center to edge of display element 80.

A signal including video information may be provided from the display circuit 87 to the display element 80. The display element 80 may generate light that is modulated based on the signal. For example, it is possible that the display element 80 may emit light including a plurality of parallax images.

For example, the first element image region 81 may comprise a plurality of first to Nth main region parallax image display portions P1˜Pn (n is the same integer as N) arranged in this order along the X direction. The second element image region 82 may comprise a plurality of first to Nth adjacent region parallax image display portions Q1˜Qn (n is the same integer as N) arranged in this order along the X direction.

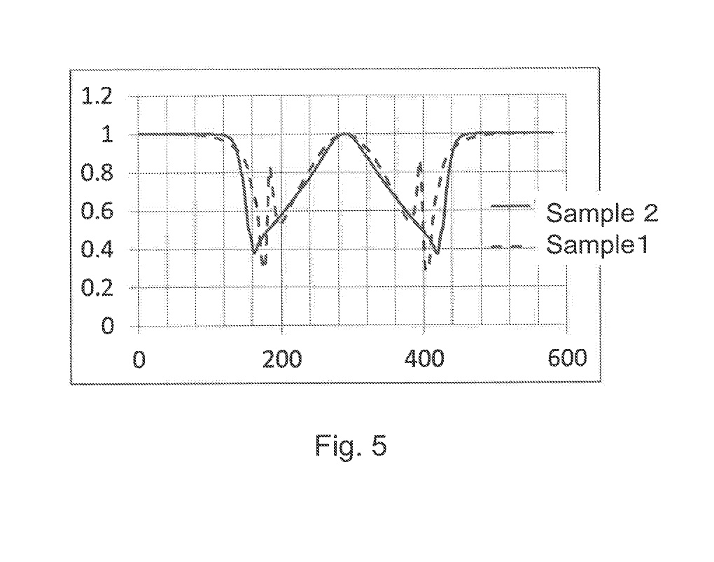

The case in which N is five is described in FIG. 5. However, it is to be understood that N is arbitrary number that may be less than or greater than 5.

Each of the first to Nth main region parallax image display portion P1˜Pn and first to Nth adjacent region parallax image display portion Q1˜Qn generates, for example, an image including a plurality of parallax information for stereovision. An observer may perceive an image by looking at the plurality of parallax images through the lens formed by liquid crystal optical device 111.

For providing a high quality stereoscopic image, it is desirable that the second portion 30b of liquid crystal layer 30 is suppressed. That is, it is desirable that reflective index n increases vertically between the first portion 30a and the third portion 30c. However, it is difficult to suppress the second portion 30b from forming in some cases.

When light from the display element 80 is incident to the second portion 30b, the light is guided in a direction that is not ideal for the generation of a parallax image. For example, stray light may be generated. In this case, for example, cross-talk may occur and the visual quality of image display apparatus 211 may be low. As the width of the second portion 30b becomes broader, the cross-talk phenomenon occurs more easily.

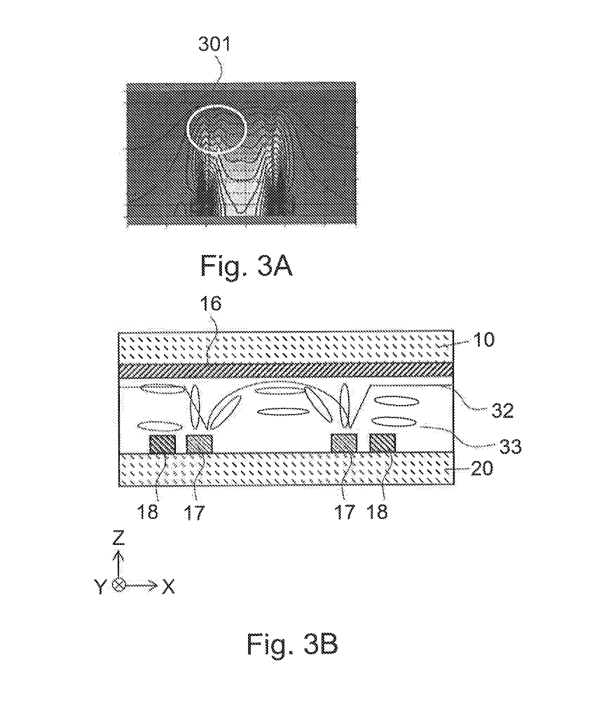

A conventional first portion 30a and second portion 30b will be described with FIG. 3. Note that the explanation of the third portion 30c will be omitted. FIG. 3A is a diagram of distribution of potentials of a refractive-index distribution, type liquid crystal optical device according to reference sample 1, and FIG. 3B is an enlarged sectional view of a part of a refractive-index distribution type liquid crystal optical device according to reference sample 1. FIG. 3A corresponds to a cross-section of FIG. 3B.

In FIG. 3B, there is a sixth electrode 16 between the first substrate 10 and liquid crystal layer 30. There is a pair of eighth electrodes 18 and a pair of seventh electrodes 17 between the second substrate 20 and liquid crystal layer 30. The pair of seventh electrodes 17 is provided between the pair of eighth electrodes 18. The sixth electrode 16 opposes the pair of seventh electrodes 17 and the pair of eighth electrodes 18. In this structure, a refractive-index distribution 32 may be caused by making a potential difference between the sixth electrode 16 and the seventh electrode 17 large and making a potential difference between the sixth electrode 16 and the eighth electrode 18 small. Directors of liquid crystal molecules are illustrated as an ellipse 33.

In order to make the change of refractive index n in the second portion 30b precipitous and to make the width of the second portion 30b narrow, providing a high voltage between the seventh electrode 17 and the sixth electrode can be considered. The case in which 0 volt (V) is applied to the sixth electrode 16, 6V is applied to the seventh electrode 17, and 0V is applied to the eighth electrode 18 is shown in FIG. 3A. However, a reverse tilt region may be formed around the seventh electrode 17 in this case.

That is, as shown in FIG. 3A, an electric field formed by the sixth electrode 16 and the seventh electrode 17 may broaden around the eighth electrode 18 because the seventh electrode 17 and the eighth electrode 18 are close to each other. In addition, an electric field formed by the sixth electrode 16 and the eighth electrode 18 may broaden outside of these. For this reason, it may be difficult to make the change of refractive index n in the second portion 30b precipitous. Furthermore, for example, as shown in region 301, a disclination may occur.

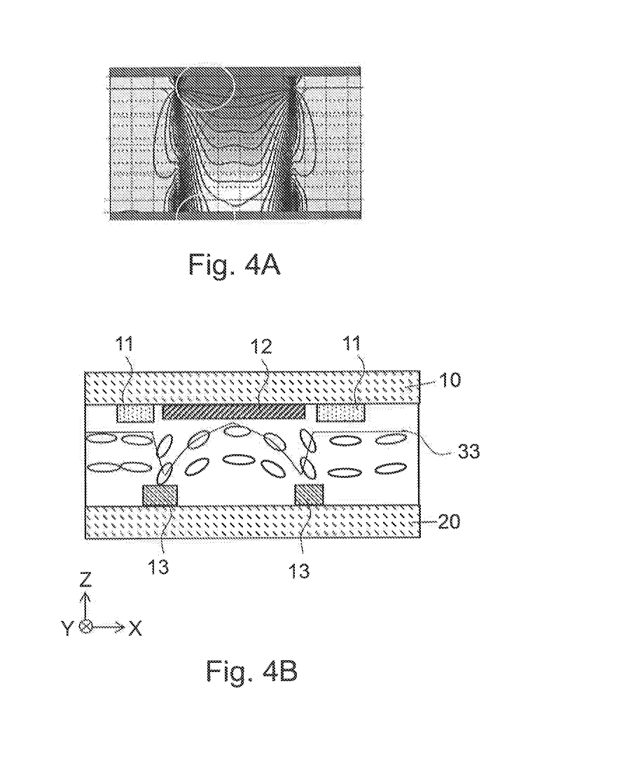

The first portion 30a and the second portion 30b according to this embodiment will be explained with reference to FIG. 4. Note that the explanation about the third portion 30c will be omitted.

FIG. 4A is a diagram of distribution of potentials of a refractive-index distribution type liquid crystal optical device according to reference sample 2. FIG. 4B is an enlarged sectional view of a part of a refractive-index distribution type liquid crystal optical device according to reference sample 2. FIG. 4A corresponds to a cross-section of FIG. 4B. FIGS. 4A and 4B show the case in which the fourth electrodes 14 in liquid crystal optical devise of FIG. 1 are omitted.

FIG. 5 is a diagram of a refractive-index distribution of refractive-index distribution type liquid crystal optical device according to reference sample 1 and reference sample 2. FIG. 5 corresponds to cross-section of FIG. 3B and FIG. 4B. The horizontal axis is in shown in the X direction and the vertical axis is shown in the Y direction.

It is possible to cause the distribution of refractive-index 34 by making the difference in potential between the second electrode 12 and the third electrode 13 large, and by making the difference in potential between the first electrode 11 and the third electrode 13 small. The case in which 0 volt (V) is applied to the first electrode 11, −4V is applied to the second electrode 12, and +2V is applied to the third electrode 13 is shown in FIG. 4A. Because it is possible to modulate an electric field in the first portion 30a and an electric field in the second portion 30b by controlling the voltage of the first electrode 11 and the second electrode 12, it is possible to make the change of refractive index n in the second portion 30b precipitous. Furthermore, because it is not necessary to broaden the difference of voltage between the second electrode 12 and the third electrode 13 too much, it is possible to suppress the disclination.

In this way, by providing two types of electrodes in a side of the first substrate 10 on which convex shape of the lenses are formed, it is possible to obtain a liquid crystal optical element 101 which functions as an ideal Fresnel lens, and thereby to provide an image display apparatus 211 having high display quality.

Each of the second electrodes 12 has a pair of edge portions 12a and a central portion 12b provided between the pair of edge portions 12a. A pair of the third electrodes 13 opposes the second electrode 12. When the second electrodes 12 and a pair of the third electrodes 13 are projected onto the first surface 10a, each of the pair of the third electrodes 13 overlaps with each of the pair of edge portions 12a of the second electrodes 12.

By opposing the edge portion 12a of the second electrode 12 to the third electrode 13, it is possible to make a deep valley of the refractive-index distribution caused between the first portion 30a and the second portion 30b in liquid crystal layer 30. That is, it is possible to obtain almost an ideal refractive-index distribution in the neighborhood of the border between the first portion 30a and the second portion 30b. The width of the end portion 12a of the second electrode 12 along the first direction may be, for example, not less than 10 μm and not more than 30 μm.

Furthermore, the width W2 of the second electrode 12 may be not less than the thickness L1 of the liquid crystal layer.

In the case that the width W2 of the second electrode 12 is narrow, the width of the second portion 30b is narrow. The broader the width W2 of the second electrode 12 is, the narrower the width of the second portion 30b is. In the case that the width W2 of the second electrode 12 is narrower than the thickness L1 of the liquid crystal, it is possible to make the width of the second portion 30b narrow.

In the case that the width W2 of the second electrode 12 is narrower than the thickness L1 of the liquid crystal layer 30, the valley of refractive-index distribution caused by electric field between the second electrode 12 and the third electrode 13 is shallow. The electric field caused by the second electrode 12 and the third electrode 13 broadens at a part between the first electrode 11 and the third electrode 13. The second portion 30b is in the side of the electric field which opposes the fourth electrode 14, at which point a width of the second portion 30b gets broad. On the other side, in the case the width W2 of the second electrode 12 is longer than the thickness L1 of the liquid crystal layer 30, it is possible to make the valley of the refractive-index distribution deep, and it is possible to suppress broadening of the width of the second portion 30b.

In this specification, the width W2 of a second electrode 12 along the first direction is constant. Furthermore, the width W3 of a third electrode 13 along the first direction is constant. In the case where the width of the second electrode 12 along the first direction is not constant, for example, the average value of the widths is defined to be the width w2. In the case that the width of the third electrode 13 along the first direction is not constant, for example, the average value of the widths is defined to be the width w3.

In this embodiment, the widths W2 of each of the plurality of second electrodes 12 are the same. And the widths W3 of each of the plurality of third electrodes 13 are the same. In the case that the widths of each the plurality of the second electrodes 12 is different, for example, the average of the plurality of the second electrodes 12 is defined to be the width W2. In the case that the widths of each the plurality of the third electrodes 13 is different, for example, the average of the plurality of the third electrodes 13 is defined to be the width W3.

When the fourth electrode 14 is projected onto the first surface 10a, the fourth electrode 14 overlaps with the center (first center) M1 of width of the first electrode 11. That is, the line passing through the first center M1 and being perpendicular to the first surface 10a passes through the fourth electrode 14.

In the first state, the controller 77 applies the voltage to each electrode so that the first voltage V1, the second voltage V2, the third voltage V3, and the fourth voltage V4 satisfy following relations:

|V2−V3|>|V1−V3| (3)

|V1−V4|>|V1−V3| (4)

By making the difference of voltage between the second voltage V2 and the third voltage V3 broad as indicated by relation (3), it is possible to make the directors of liquid crystal rise, so that the valley of refraction-index distribution between the first portion 30a and the second portion 30b is formed. By making the difference of voltage between the first voltage V1 and the third voltage V3 narrow, the liquid crystal director is suppressed from rising, so that the peak of the refractive-index between the second portion 30b and the third portion 30c is formed.

For example, the voltage V1−V3 may be set so that the first voltage V1 is higher than the second voltage V2, the third voltage V3 is not less than the first voltage V1, and the relation (3) is satisfied. It is desirable that the difference between the first voltage V1 and the third voltage V3 is almost 0V.

The edge portions of Fresnel lens have the lowest refractive-index in the Fresnel lens. By making the difference in voltage between the first electrode 11 and the fourth electrode 14 broader than the difference in voltage between the first electrode 11 and the third electrode 13, it is possible to obtain almost an ideal refractive-index distribution in the third portion 30c. That is, in a case that the relation (4) is satisfied, the further the third portion 30c is from the second portion 30b, the lower the refractive-index is.

It is preferred that a length G1 of a gap between a first electrode 11 and a second electrode 12 provided proximate to the first electrode 11 along the X direction is not more than the thickness L1 of liquid crystal layer 30 along the S direction. In this way, by providing the first electrode 11 and the second electrode 12, it is possible to make the width of the second portion 30b narrow.

The mechanism for forming of the refraction-index distribution of second portion 30b will be explained. When different voltages are applied to the first electrode 11 and the second electrode 12, an equivalence line extends from the gap between the first electrode 11 and the second electrode 12 along 2 direction, and the electric field having a gradient of voltage along X direction is formed. The narrower the gap between the first electrode 11 and the second electrode 12 is, the higher the density of a plurality of the equivalence lines.

The plurality of the equivalence lines extend from the side of the first substrate 10 to the side of the second substrate 20 while keeping the gaps. In the area of the equivalence lines, directors of liquid crystal molecules rise along the Y direction. By making the gap between the first electrode 11 and the second electrode 12 narrow, it is possible to make the width of the electric field narrow, so that the rising of liquid crystal directors becomes precipitous, and the width of the second portion 30b is narrow. It is desirable that the length G1 of the gap between the first electrode 11 and the second electrode 12 is as narrow as possible. For example, the length G1 may be not more than the thickness L1 of liquid crystal layer 30. For example, the length G1 of the gap may be not more than 20 μm.

Note that, in this embodiment, the length G1 of gap between a first electrode 11 and a second electrode 12 provided proximate to the first electrode 11 along the X direction is constant. In the case that the length is not constant, for example, the average of the lengths is defined as the length G1. Furthermore, in the case that the lengths of gaps between a plurality of the first electrodes 11 and second electrodes 12 are different, for example, the average is the length G1.

The thickness of liquid crystal layer 30 is a distance between the first substrate unit 10u and the second substrate unit 20u. For example, in the case that each of the first substrate unit 10u and the second substrate unit 20u has an alignment film, the distance of each of the alignment films is the thickness of liquid crystal layer 30.

### Second Embodiment

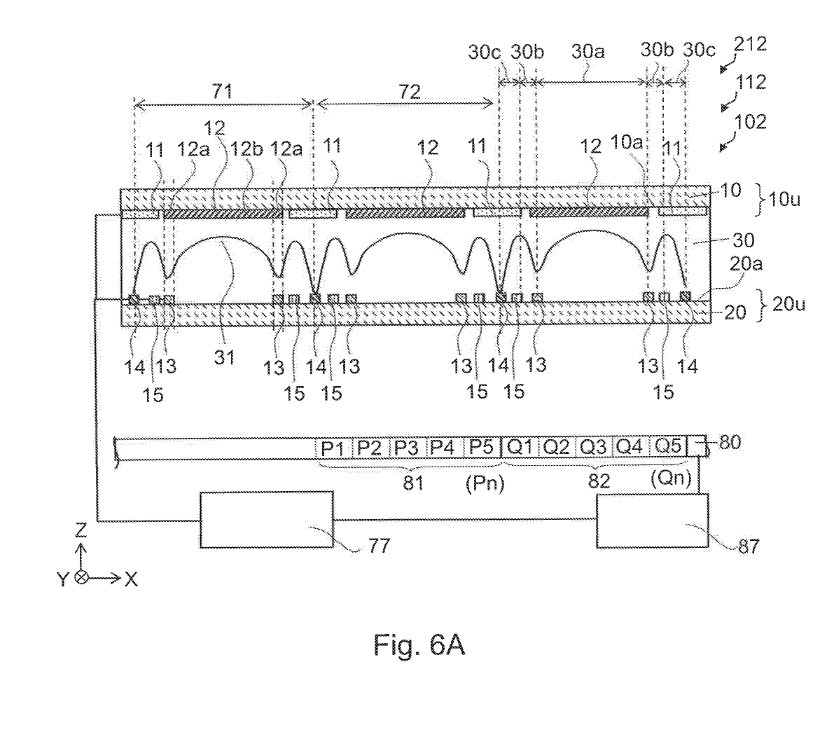

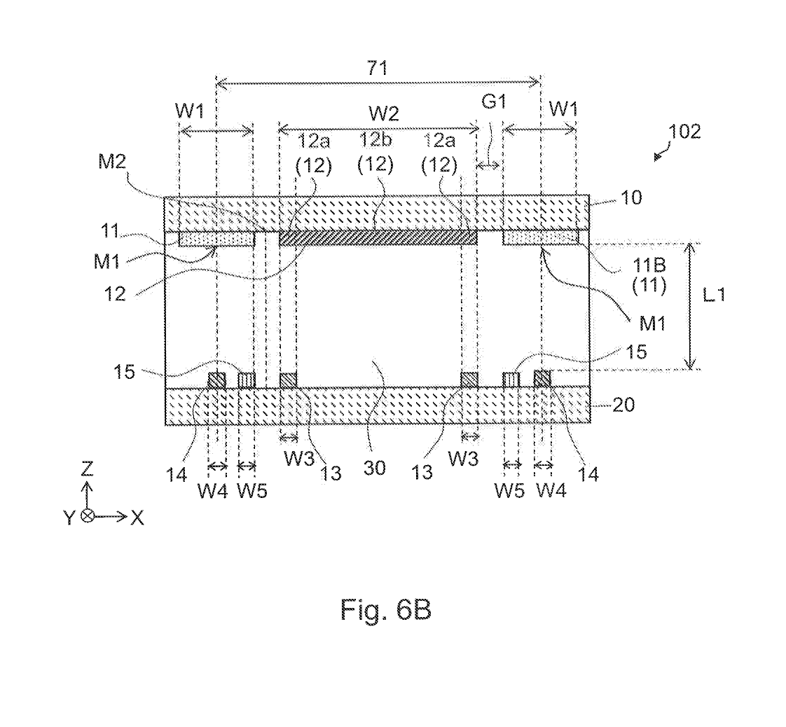

Compositions being same as compositions in the first embodiment will be denoted by the same reference numerals and description thereof will be omitted. FIG. 6A is a sectional view illustrating an image display apparatus according to a second embodiment. FIG. 6B is an enlarged view illustrating a part of an image display apparatus shown in FIG. 6A. A liquid crystal optical device 112 of an image display apparatus 212 comprises a liquid crystal optical element 102 in this embodiment. The liquid crystal optical element 102 comprises the second substrate unit 20u further comprising a fifth electrode 15.

The fifth electrode 15 is provided between the second substrate 20 and the liquid crystal layer 30. The fifth electrode 15 is provided between the third electrode 13 and the fourth electrode 14. A pair of fifth electrodes 15 is provided between a pair of fourth electrodes 14.

When the third electrode 13 and the fifth electrode 15 projected onto the first surface 10a, a second center M2 of line segment connecting the first electrode 11 and the second electrode 12 along X direction may be between the third electrode 13 and the fifth electrode 15.

An arrangement of the third electrode 13 and the fifth electrode 15 will be explained. It is desirable that the second electrode 12 and the third electrode 13 cause strong coupling action to form the first portion 30a. For this, it is desirable not to occur the coupling action between the third electrode 13 and the first electrode. For this reason, it is desirable that the third electrode 13 does not overlap with the first center M1 when the third electrode 13 is projected onto the first surface 10a. That is, in XZ plane, the third electrode 13 may be provided in the side of the line passing through the first center M1 and being perpendicular to Z direction where it is near the center portion 12a of the second electrode 12.

On the other hand, it is desirable that the first electrode 11 and the fifth electrode 15 cause strong coupling action to form the second portion 30b. For this, the fifth electrode 15 may be provided so that that the fifth electrode 15 does not overlap with the first center M1 when the fifth electrode 15 is projected onto the first surface 10a. That is, in XZ plane, the fifth electrode 15 is provided in the side of the line passing through the first center M1 and being perpendicular to Z direction where it is near the first electrode 11.

For example, in first embodiment, it may be difficult to form desirable refractive-index distribution due to a material of liquid crystal layer 30 and values of voltage applied to each of the electrodes in the liquid crystal optical device 111. A disarray of refractive-index distribution may be caused due to a material of the liquid crystal layer 30 especially in the second portion 30b of the liquid crystal layer 30. However, in the case where the fifth electrode 15 is provided, it may be possible to form the desirable refractive-index distribution because it is possible to adjust the refractive-index distribution between the third electrode 13 and the fourth electrode 14.

For this reason, by this embodiment, it is possible to provide an image display apparatus 212 having high display quality.

For example, the width W2 of the second electrode 12 along X direction may be not less than the width W5 of the fifth electrode 15. For example, the width W3 of the third electrode 13 along X direction may not be more than the width W5 of the fifth electrode 15. The material same as the first through fourth electrode 11-14 may be used for the fifth electrode 15. The width W5 of the fifth electrode 15 may be, for example, not less than 10 μm and not more than 30 μm. The gap between the third electrode 13 and the fifth electrode 15 may be, for example, not less than 10 μm and not more than 20 μm. The gap between the fourth electrode 14 and the fifth electrode 15 may be, for example, not less than 20 μm and not more than 70 μm. The gap between the fourth electrode 14 and the fifth electrode 15 may be set to obtain an desirable refrax-index distribution of the third portion 30b. For example, the gap between third electrode 13 and the fifth electrode 15 may be narrow.

The controller 77 may apply the fifth voltage V5 to the fifth electrode 15.

It is desirable that the first voltage V1, the second voltage V2, the third voltage V3, and the fifth voltage V5 satisfy the following relation.

$$\vert ( \frac{V 3 + V 5}{2} ) - V 2 \vert > \vert ( \frac{V 3 + V 5}{2} ) - V 1 \vert \qquad ( 5 )$$

An area on the second substrate 20 where the third electrode 13 and the fifth electrode 15 provided may be assumed to be applied the mean voltage VA of the third electrode 13 and the fifth electrode 15. As relation (5), by making a small difference of voltages between the second voltage V2 and the mean voltage VA, it may be possible to rise the liquid crystal directors, and the valley of the refractive-index distribution between the second portion 30b and the third portion 30c is formed.

For example, it may be possible to set each voltage so that the first voltage V1 is lower than the second voltage V2, the mean voltage VA is lower than the first voltage V1, and the relation (5) is satisfied. It is desirable that the absolute value of the difference of voltages between the mean voltage VA and the second voltage V2 is not less than the threshold voltage Vth of the liquid crystal layer 30. It is desirable that the absolute value of the difference of voltages between the mean voltage VA and the first voltage V1 is not more than the threshold voltage Vth of the liquid crystal layer 30.

It is desirable that the first voltage V1, the second voltage V2, the third voltage V3, and the fifth voltage V5 satisfy the following relation in addition to relation (5).

|V2−V3|>|V1−V5| (6)

An electric field is caused between the second electrode 12 and the part of the third electrode 13 being near the second electrode 12 due to the second voltage V2 and the third voltage V3. Furthermore, an electric field is caused between the first electrode 11 and the part of the fifth electrode 15 being near the first electrode 11 due to the first voltage V1 and the fifth voltage V5. In the case the relation (6) is satisfied it is possible to obtain almost a desirable refractive-index distribution. It is desirable that the difference between the first, voltage V1 and the fifth voltage V5 is almost zero.

It is desirable that the first voltage V1, the second voltage V2, the third voltage V3, and the fifth voltage V5 satisfy the following relation.

(V2−V1)/(V3−V5)<0 (7)

When each voltage is set, the high-low relationship of voltages along X direction in the first substrate unit 10u is reverse the high-low relationships in the second substrate unit 20u. For example, on one hand, in a part of the liquid crystal layer 30 near the first substrate unit 10u, a voltage of a side of the first electrode 11 is higher than a voltage of a side of the second electrode 12. On the other hand, in other part of the liquid crystal layer 30 near the second substrate unit 20u, a voltage of a side of the third, electrode 13 is higher than a voltage of a side of the fifth electrode 15. By this, it is easy to cause a local maximum value of refractive-index of distribution between the second portion 30b and the third portion 30c of liquid crystal layer 30. For this reason, it is possible to obtain almost an ideal refractive-index distribution.

### Third Embodiment

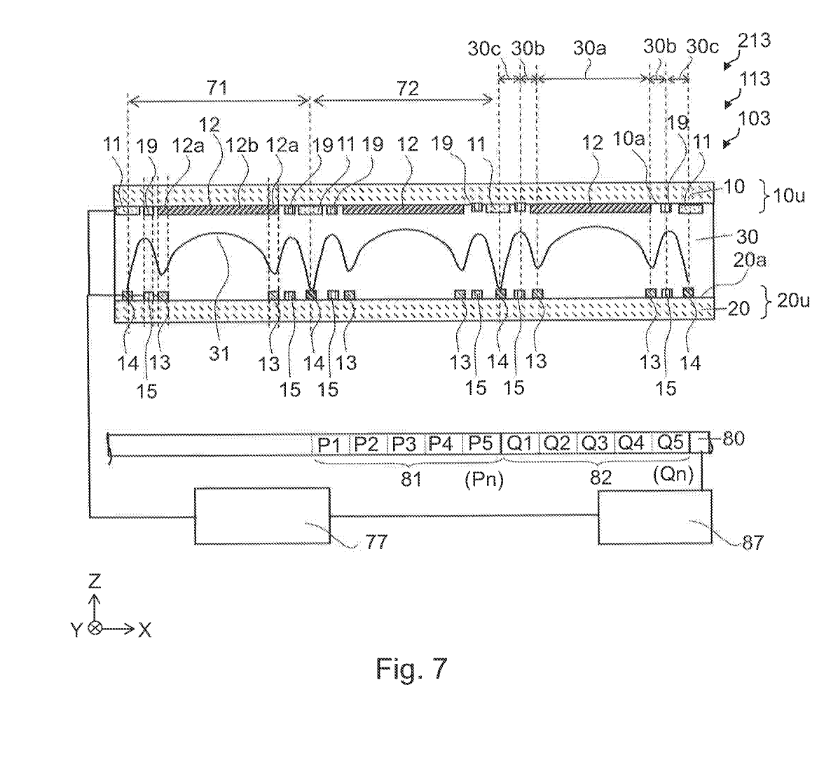

Compositions being same as these in the second embodiment will be denoted by the same reference numerals and description thereof will be omitted. FIG. 7 is a sectional view illustrating an image display apparatus according to a third embodiment. In this embodiment, a liquid crystal optical device 113 of an image display apparatus 213 comprises a liquid crystal optical element 103. The first substrate unit 10u of the liquid crystal optical element 103 furthermore comprises a ninth electrode 19.

In this embodiment, the second substrate unit 20u may be same as the second substrate unit 20u in the second embodiment. For example, the second substrate unit 20 may not be comprises the fifth electrode 15.

The ninth electrode 19 is provided between the first substrate 10 and liquid crystal layer 30. The ninth electrode 19 is provided between the first electrode 11 and the second electrode 12. The second electrode is provided between a pair of the ninth electrodes 19. I the case where the fifth electrode 15 is provided, at least a portion of the fifth electrode 15 opposes to at least a portion of the ninth electrode 19. That is, in the case where the fifth electrode 15 is projected onto the first surface 10a, the fifth electrode 15 overlaps at least a portion of the ninth electrode 19.

In the case where the ninth electrode 19 is provided, due to the distribution of voltages caused between the first electrode 11 and the second electrode 12, it may be possible to cause more desirable refractive-index distribution 31.

For this reason, by this embodiment, it may be possible to provide an image display apparatus 213 having high display quality.

For example, each voltage satisfies following relations.

V2≦V1≦V9 (8)

|((V3+V5)/2)−V2|>|((V3+V5)/2)−V9| (9)

|V2−V3|>|V9−V5| (10)

When each voltage satisfies these relations, it may be possible to cause a narrow second portion 30b. Furthermore, the more far a part of the third portion 30c is from the first portion 30a, the lower the refractive index of the part may be.

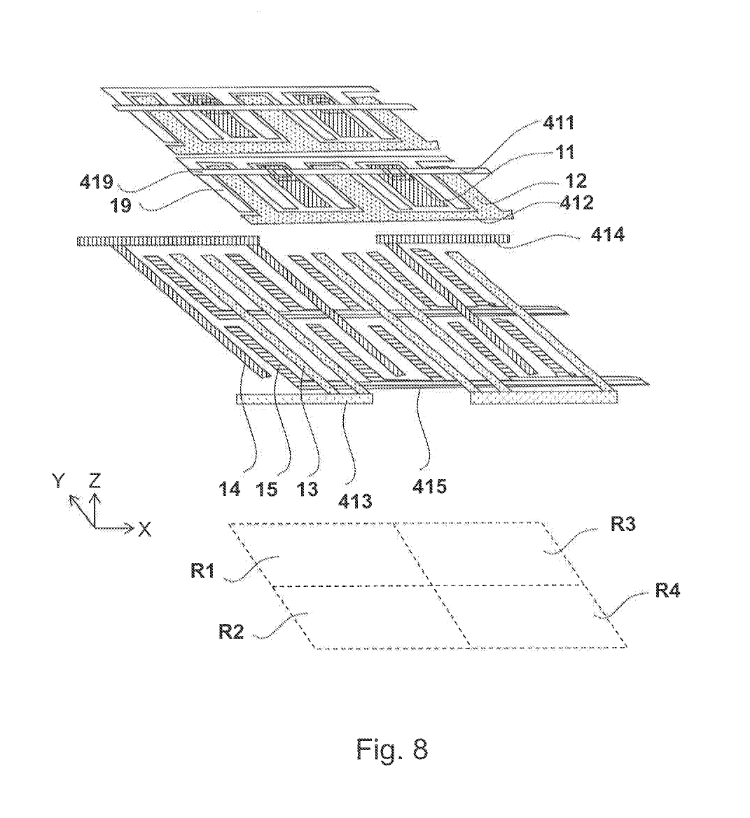

FIG. 8 is an exploded perspective view illustrating electrodes according to the third embodiment. Each of the adjacent first electrodes 11, each of the adjacent second electrodes 12, each of the adjacent third electrodes 13, each of the adjacent fourth electrodes 14, each of the adjacent fifth electrodes 15, and each of the adjacent ninth electrodes 19 may be connected by connecting portions 414˜419.

Groups consisting of first electrodes 11 connected each other may be arranged along Y direction. Groups consisting of second electrodes 12 connected each other may be arranged along Y direction. Groups consisting of fifth electrodes 15 connected each other may be arranged along Y direction. Groups consisting of ninth electrodes 19 connected each other may be arranged along Y direction. On the other hand, groups consisting of third electrodes 13 connected each other may be arranged along X direction. Groups consisting of fourth electrodes 14 connected each other may be arranged along X direction.

For example, the controller 77 may provide two types of voltages to each of those electrodes. For example, the controller 77 may provide a first high voltage V1H and first low voltage V1L to the first electrode 11. For example, the controller 77 may provide a second high voltage V2H and second low voltage V2L to the second electrode 12. For example, the controller 77 may provide a third high voltage V3H and third low voltage V3L to the third electrode 13. For example, the controller 77 may provide a fourth high voltage V4H and fourth low voltage V4L to the fourth electrode 14. For example, the controller 77 may provide a fifth high voltage V5H and fifth low voltage V5L to the fifth electrode 15. For example, the controller 77 may provide a ninth high voltage V9H and ninth low voltage V9L to the ninth electrode 19. By the controller 77 switching the voltages to provide to each electrode, it may be possible to switch the image display apparatus between three-dimensional display and two-dimensional display partially. That is, it may be possible to switch three-dimensional image and two-dimensional image in each of regions (a first region R1, a second region R2, a third region R3, and a fourth region R4) arranged along a surface parallel to XY plane.

For example, when the low voltages are provided to each of the first electrode 11, the second electrode 12, the fifth electrode 15, and the ninth electrode 13 and the high voltages are provided to each of the third electrode 13 and the fourth electrode 14 in one region and the relation (8)˜(10) are satisfied, it may be possible to display three-dimensional image in this region. In this case, in particular, relations (11) and (12) may be satisfied.

$$\begin{matrix}\vert ( \frac{V 3 H + V 5 H}{2} ) - V 2 L \vert > Vth & ( 11 ) \\ \vert ( \frac{V 3 H + V 5 H}{2} ) - V 9 L \vert ≦ Vth & ( 12 )\end{matrix}$$

On the other hand, when the high voltages are provided to the first electrode 11, the second electrode 12, the fifth electrode 15, and the ninth electrode 19 and the high voltages are provided to the third electrode 13 and the fourth electrode 14, it may be possible to display two-dimensional image (a first two-dimensional mode). For example, the voltages of each electrode may satisfy following relations.

$$\begin{matrix}\vert ( \frac{V 3 H + V 5 H}{2} ) - V 2 H \vert ≦ Vth & ( 13 ) \\ \vert ( \frac{V 3 H + V 5 H}{2} ) - V 9 H \vert ≦ Vth & ( 14 )\end{matrix}$$

When the low voltages are provided to the first electrode 11, the second electrode 12, the fifth electrode 15, and the ninth electrode 19 and the low voltages are provided to the third electrode 13 and the fourth electrode 14, it may be possible to display two-dimensional image (a second two-dimensional mode). For example, the voltages of each electrode may satisfy following relations.

$$\begin{matrix}\vert ( \frac{V 3 L + V 5 L}{2} ) - V 2 L \vert ≦ Vth & ( 15 ) \\ \vert ( \frac{V 3 L + V 5 L}{2} ) - V 9 L \vert ≦ Vth & ( 16 )\end{matrix}$$

When the high voltages are provided to the first electrode 11, the second electrode 12, the fifth electrode 15, and the ninth electrode 19 and the low voltages are provided to the third electrode 13 and the fourth electrode 14, it may be possible to display two-dimensional image (a third, two-dimensional mode). For example, the voltages of each electrode may satisfy following relations.

$$\begin{matrix}\vert ( \frac{V 3 L + V 5 L}{2} ) - V 2 \vert ≦ Vth & ( 17 ) \\ \vert ( \frac{V 3 L + V 5 L}{2} ) - V 9 H \vert ≦ Vth & ( 18 )\end{matrix}$$

In the case of two-dimensional display, the refractive-index distribution may not be caused.

### Fourth Embodiment

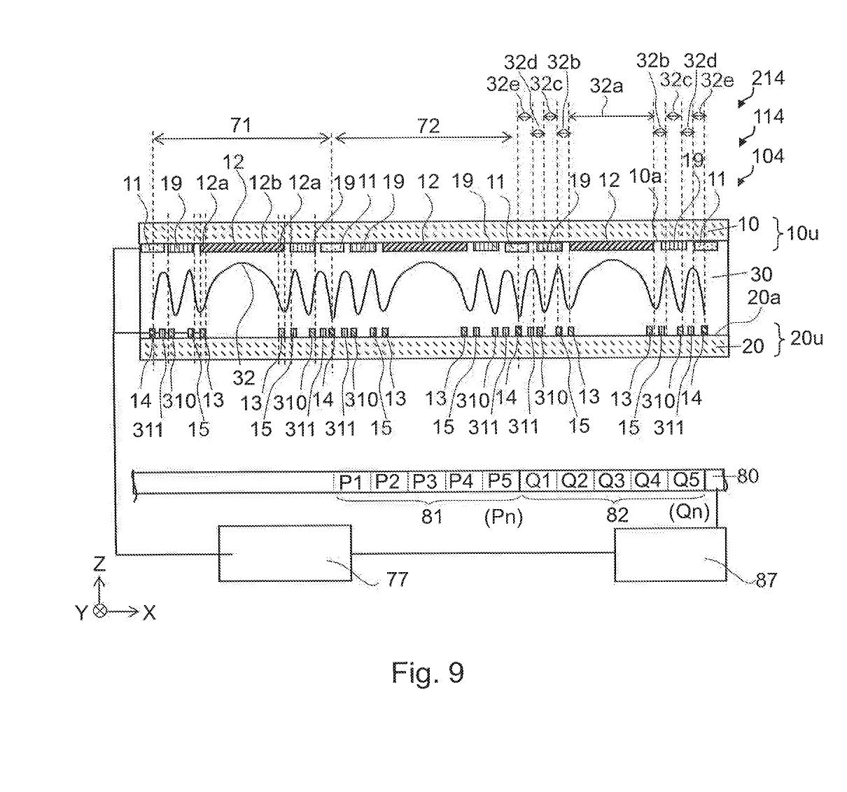

Compositions being same as these in the third embodiment will be denoted by the same reference numerals and description thereof will be omitted. FIG. 9 is a sectional view illustrating an image display apparatus according to a fourth embodiment. In this embodiment, the liquid crystal optical device 114 of an image display apparatus 214 comprises a liquid crystal optical element 104. The second substrate portion 20u of the liquid crystal optical element 104 further comprises a tenth electrode 310 and a eleventh electrode 311.

The tenth electrode 310 and the eleventh electrode 311 are provided between the second substrate 20 and the liquid crystal layer 30. The tenth electrode 310 is provided between the fourth electrode 14 and the fifth electrode 15. The eleventh electrode 311 is provided between the tenth electrode 310 and the fourth electrode 14. A pair of the tenth electrodes 310 and a pair of the eleventh electrodes 311 are provided between a pair of the fourth electrodes 14.

In this embodiment, the refractive-index distribution 32 comprises a first portion 32a opposing to the center portion 12b of the second electrode 12, a fifth portion 32e opposing to the fourth electrode 14, a second portion 32b provided between the first portion 32a and the fifth portion 32e, a third portion 32c provided between the second portion 32b and the fifth portion 32e, and a fourth portion 32d provided between the third portion 32c and the fifth portion 32e. The second portion 32b and the fourth portion 32d are portions so that the nearer a part of these portions is to the first portion 32a, the less the refractive index is. The third portion 32c and the fifth portion 32e are portions so that the nearer a part of these portions is to the first portion 32a, the greater the refractive index is.

That is, double Fresnel lenses were formed in the first embodiment, second embodiment, and third embodiment, and triple Fresnel lens is formed in this embodiment.

In the case where the tenth electrode 310 and the eleventh electrode 311 are provided, by adjusting the distribution of voltage caused between the fourth electrode 14 and the fifth electrode 15, it may be possible to increase the number of the peak of refractive index.

In this embodiment, it may be possible to form an desirable refractive index 32. For this reason, by this embodiment, it is possible to provide an image display apparatus 214 having high display quality.

Note that, in this disclosure, the terms “perpendicular” and “parallel” means not only accurately-perpendicular and accurately-parallel but also includes variation by a manufacturing error, and it is permitted to be substantially perpendicular and substantially parallel.

Each of the embodiments was described with specific examples. However, this disclosure is not limited to these specific examples. For example, one of ordinary skill in the art will understand that this disclosure may be implemented using available variations in the specific composition of each element like the liquid crystal optical element, the first substrate unit, the second substrate unit, the liquid crystal layer, the first substrate, second substrate, each of the electrodes, controller, display unit and display circuit.

One of ordinary skill in the art will also understand that this disclosure may be implemented using combinations of two or more elements from the specific examples.

One of ordinary skill in the art will also understand that this disclosure may be implemented using other optical devices and image display apparatuses.

While certain embodiments have been described, these embodiments have been presented by way of example only, and are not intended to limit the scope of the disclosure. Indeed, the embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

1. A refractive-index distribution type liquid crystal optical device comprising:
an optical element comprising:
a first substrate having a surface;
a second substrate;
a liquid crystal layer being between the surface of the first substrate and the second substrate;
a plurality of first electrodes being between the surface of the first substrate and the liquid crystal layer and arranged along a first direction parallel to the surface;
a plurality of second electrodes being between the surface of the first substrate and the liquid crystal layer, each of the plurality of second electrodes being between the plurality of first electrodes, each of the plurality of second electrodes having a pair of end portions and a center portion being between the pair of the end portions;
a plurality of pairs of third electrodes being between the second substrate and the liquid crystal layer;
a plurality of pairs of fourth electrodes being between the second substrate and the liquid crystal layer, the plurality of pairs of fourth electrodes being arranged along the first direction with the plurality of pairs of third electrodes; and
a controller configured to apply a first voltage to the plurality of the first electrodes, a second voltage to the plurality of the second electrodes, a third voltage to the plurality of pairs of third electrodes, a fourth voltage to the plurality of pairs of fourth electrodes,
wherein the pairs of third electrodes are provided between the pairs of fourth electrodes,
each of the plurality of pairs of fourth electrodes overlaps with each of first centers of widths of the first electrodes along the first direction when the plurality of pairs of fourth electrodes are projected, onto the surface,
each of the pair of third electrodes overlaps with each of the pairs of end portions of the second electrodes when the plurality of the second electrodes and the plurality of pairs of third electrodes are projected onto the surface,
the first voltage, the second voltage, the third voltage, and the fourth voltage satisfy following relations,

|V2−V3|>|V1−V3|
|V1−V4|>|V1−V3|

where V1 is the first voltage, V2 is the second voltage, V3 is the third voltage, and V4 is the fourth voltage.

2. The device according to claim 1, wherein a length of a gap between the first electrode and the second electrode proximate to the first electrode along the first direction is not more than the thickness of the liquid crystal layer along a second direction perpendicular to the surface.

3. The device according to claim 1, wherein a width of the second electrode along with the first direction is not less than the thickness of the liquid crystal layer along a second direction perpendicular to the surface.

4. The device according to claim 1, wherein the first voltage is greater than the second voltage and the third voltage is not less than the first voltage.

5. The device according to claim 1, further comprising a plurality of fifth electrodes being between the second substrate and the liquid crystal layer, each of the fifth electrodes being between the third electrodes and the fourth electrodes.

6. The device according to claim 5, wherein a second center of a line segment connecting the first electrode and the second electrode along the first direction is between the third electrode and the fifth electrode when the third electrode and the fifth electrode are projected onto the surface.

7. The device according to claim 5, wherein the controller applies a fifth voltage to the plurality of pairs of fifth electrodes,
the first voltage, the second voltage, the third voltage, and the fifth voltage are satisfy following relations,
$$\vert ( \frac{V 3 + V 5}{2} ) - V 2 \vert > \vert ( \frac{V 3 + V 5}{2} ) - V 1 \vert$$
$$\vert V 2 - V 3 \vert > \vert V 1 - V 5 \vert$$
where V5 is the fifth voltage.

8. The device according to claim 5, wherein the controller applies a fifth voltage to the fifth electrode,
the first voltage, the second voltage, the third voltage, and the fifth voltage satisfying the following relations,
(V2−V1)×(V3−V5)<0
where V5 is the fifth voltage.

9. The device according to claim 5 farther comprising a plurality of sixth electrodes provided between the first substrate and the liquid crystal layer, each of a plurality of sixth electrodes being between the first electrodes and the second electrodes.

10. The device according to claim 9 further comprising a plurality of seventh electrodes and a plurality of eighth electrodes provided between the second substrate and the liquid crystal layer,
wherein each of a plurality of seventh electrodes being between the fourth electrodes and the fifth electrodes and each of a plurality of eighth electrodes being between the fourth electrodes and the seventh electrodes

11. An image display apparatus comprising:
a refractive-index distribution type liquid crystal optical device according to claim 1; and
a display element stacked with the device and emitting an image toward the device.

12. A liquid crystal optical element comprising:
a first substrate having a surface;
a second substrate provided between the first substrate and a display element;
a liquid crystal layer being between the surface of the first substrate and the second substrate;
a pair of first electrodes being between the surface of the first substrate and the liquid crystal layer and arranged along a first direction parallel to the surface;
a second electrode being between the surface of the first substrate and the liquid crystal layer, the second electrode being between the pair of first electrodes, the second electrode having a pair of end portions and a center portion being between the pair of end portions;
a pair of third electrodes being between the second substrate and the liquid crystal layer, each of the pair of third electrodes overlaps with each of the pair of the end portions of the second electrodes when the second electrode and the pair of third electrodes are projected onto the surface.

13. The element according to the claim 12 further comprising a pair of fourth electrodes being between the second substrate and the liquid crystal layer, the pair of the fourth electrodes being arranged along the first direction with the pair of the third electrodes,
wherein the pair of third electrodes are provided between the pair of fourth electrodes,
each of the pair the fourth electrodes overlaps with each of first centers of widths of the first electrodes along the first direction when the fourth electrodes are projected onto the surface.

14. The element according to claim 13, further comprising a pair of fifth electrode being between the second substrate and the crystal layer, each of the pair of fifth electrode being between the third electrode and the fourth electrode.

15. The element according to claim 14, wherein a second center of a line segment connecting the first electrode and the second electrode along the first direction is between the third electrode and the fifth electrode when the third electrode and the fifth electrode are projected onto the surface.

16. A refractive-index distribution type liquid crystal optical device comprising:
a liquid crystal optical element according to claim 12; and
a controller configured to apply a first voltage to the pair of first electrodes, a second voltage to the second electrodes, a third voltage to the pair of third electrodes,
the first voltage, the second voltage, and the third voltage satisfies following relations,

|V2−V3|>|V1−V3|

Where V1 is the first voltage, V2 is the second voltage, and V3 is the third voltage.

17. A refractive-index distribution type liquid crystal optical device comprising:
a liquid crystal optical element according to claim. 13; and
further comprising a controller configured to apply a first voltage to the pair of first electrodes, a second voltage to the second electrodes, a third voltage to the pair of the third electrodes, and a fourth voltage to the pair of fourth electrodes,
the first voltage, the second voltage, the third voltage, and the fourth voltage satisfy following relations,

|V2−V3|>|V1−V3|
|V1−V4|>|V1−V3|

where V1 is the first voltage, V2 is the second voltage, V3 is the third voltage, and V4 is the fourth voltage.
